(19) United States
(12) Patent Application Publication
(10) Pub. No.: US 2026/0129683 A1
(43) Pub. Date: May 7, 2026

(54) DYNAMIC REDISTRIBUTION OF RANDOM ACCESS CHANNEL PREAMBLE RESOURCES

(71) Applicant: Dell Products L.P., Round Rock, TX (US)

(72) Inventors: Ravi Sharma, Cupertino, CA (US); Yasser Al-Eryani, Kanata (CA); Vikas Arora, Ottawa (CA)

(21) Appl. No.: 18/936,162

(22) Filed: Nov. 4, 2024

(51) Int. Cl. H04W 74/0833; H04W 24/02

(52) U.S. Cl. CPC H04W 74/0833; H04W 24/02

(57) ABSTRACT

A method facilitating dynamic redistribution of random access channel (RACH) preamble resources includes facilitating, by a system including at least one processor, submitting a network performance measurement, relating to a performance indicator of a communication network, to a reinforcement learning model; adjusting, by the system based on an output generated by the reinforcement learning model in response to the network performance measurement, a partitioning of a group of RACH preambles, used by the communication network, between a first subgroup of contention-based RACH preambles and a second subgroup of non-contention-based RACH preambles, resulting in an adjusted partitioning of the RACH preambles; and causing, by the system in response to the adjusting, a base station to transmit data relating to the adjusted partitioning of the RACH preambles via a system information broadcast.

### BACKGROUND

Modern wireless communication networks, such as those built on the Long Term Evolution (LTE) and/or fifth generation (5G) New Radio (NR) standards, rely on the efficient management of random access channel (RACH) preambles for various purposes, e.g., establishing initial communication between user equipment (UE) and a base station and/or facilitating activities like network entry, handovers, or resource requests. RACH preambles are categorized into contention-based preambles, which are used in scenarios in which potential collisions can occur due to multiple UEs simultaneously attempting access, and non-contention-based (or contention-free) preambles, which are used in scenarios in which the risk of collision is minimal.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include inputting measurement data, relating to a performance metric associated with a communication network, to a reinforcement learning model. The operations can further include adjusting, based on an output generated by the reinforcement learning model in response to the inputting of the measurement data, an allocation of random access channel (RACH) preambles, used by the communication network, between a first group of contention-based RACH preambles and a second group of non-contention-based RACH preambles, resulting in an adjusted allocation of the RACH preambles. The operations can additionally include causing, in response to the adjusting of the allocation of the RACH preambles, a Node B to transmit information relating to the adjusted allocation of the RACH preambles via a system information broadcast.

In another implementation, a method is described herein. The method can include facilitating, by a system including at least one processor, submitting a network performance measurement, relating to a performance indicator of a communication network, to a reinforcement learning model. The method can also include adjusting, by the system based on an output generated by the reinforcement learning model in response to the network performance measurement, a partitioning of a group of RACH preambles, used by the communication network, between a first subgroup of contention-based RACH preambles and a second subgroup of non-contention-based RACH preambles, resulting in an adjusted partitioning of the RACH preambles. The method can further include causing, by the system in response to the adjusting, a base station to transmit data relating to the adjusted partitioning of the RACH preambles via a system information broadcast.

In an additional implementation, a non-transitory machine-readable medium is described herein that can include instructions that, when executed by at least one processor, facilitate performance of operations. The operations can include providing an input to a machine learning model, the input being indicative of a key performance indicator (KPI) corresponding to performance of a communication network; based on an output generated by the machine learning model in response to the input, adjusting a division of a group of RACH preambles, used by the communication network, into a first subgroup of contention-based RACH preambles and a second subgroup of non-contention-based RACH preambles; and causing, in response to the adjusting of the division, Node B network equipment to transmit a system information broadcast comprising data indicative of the first subgroup of contention-based RACH preambles and the second subgroup of non-contention-based RACH preambles.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates dynamic redistribution of random access channel (RACH) preamble resources in accordance with various implementations described herein.

FIGS. 2-3 are diagrams illustrating example random access procedures that can be utilized by devices in a communication network in accordance with various implementations described herein.

FIGS. 4-8 are block diagrams of additional systems that facilitate dynamic redistribution of RACH preamble resources in accordance with various implementations described herein.

FIGS. 9-10 are flow diagrams of respective methods that facilitate dynamic redistribution of RACH preamble resources in accordance with various implementations described herein.

FIG. 11 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Implementations described herein can provide a comprehensive solution for optimizing the allocation of random access channel (RACH) preambles in a wireless communication network using one or more machine learning techniques such as reinforcement learning (RL), deep reinforcement learning (DRL), and/or other suitable techniques. Implementations described herein can enhance key performance indicators (KPIs) such as access delay, collision rate, successful access rate, throughput, handover success rate, or the like by dynamically adjusting preamble allocations based on real-time network conditions.

Implementations described herein can additionally provide an architecture that integrates multiple network components, including user equipment (UE), base stations (e.g., Node B equipment), and the core network, with advanced data collection and pre-processing mechanisms. Some implementations described herein can employ a DRL agent, which can include components such as a state representation module, a policy network, a reward function module, an experience replay buffer, and a training module, to facilitate advanced decision-making regarding RACH preamble allocation via a process that includes a training phase and an inference phase. During the training phase, the agent can undergo both offline training (e.g., with historical data and simulations) and online training (e.g., with real-time data). In the inference phase, the trained policy network can make real-time decisions on preamble allocation, which can then be executed and continuously monitored for performance feedback. In addition, the system can employ robust measurement technologies, including network probes, sensors, and big data analytics, to ensure accurate and efficient optimization. Implementations described herein can additionally facilitate the integration of

DRL with the radio access network (RAN), resulting in improved network performance through adaptive and intelligent preamble allocation.

By utilizing one or more implementations as described herein, the performance of a wireless communication system can be improved via the dynamic repartitioning of RACH preamble resources using automated processes that can operate at a higher level of complexity than is possible to be performed manually by a human, e.g., due to the number of calculations and/or other operations performed in parallel, the number of network measurements or other data points that can be processed simultaneously, and/or other factors. Additionally, implementations described herein can facilitate, via the use of application programming interface (API)-layer integration and/or other mechanisms for interfacing with network equipment as will be described herein, directly controlling a Node B or other suitable network equipment to perform actions relating to the performance of the network, such as reallocating a RACH preamble partition space and/or transmitting information relating to the state of the RACH preamble partition space, without the need for manual (human) intervention. This can, in turn, provide faster and more complete adaptation of a communication network to changing network conditions than that which is possible via a human network operator performing manual actions.

With regard to the following description, it is noted that any references to specific network components, standards, technologies, or the like, are made merely by way of example and are not intended to limit the scope of the description or the claimed subject matter unless explicitly stated otherwise. For instance, while various examples provided herein relate to examples involving long-term evolution (LTE) networks that include evolved Node B (eNodeB or eNB) devices, fifth generation (5G) new radio (NR) networks that include next-generation Node B (gNodeB or gNB) devices, or the like, it is noted that similar concepts to those described herein could also be applied to other network types, either in addition to or in place of the named network types.

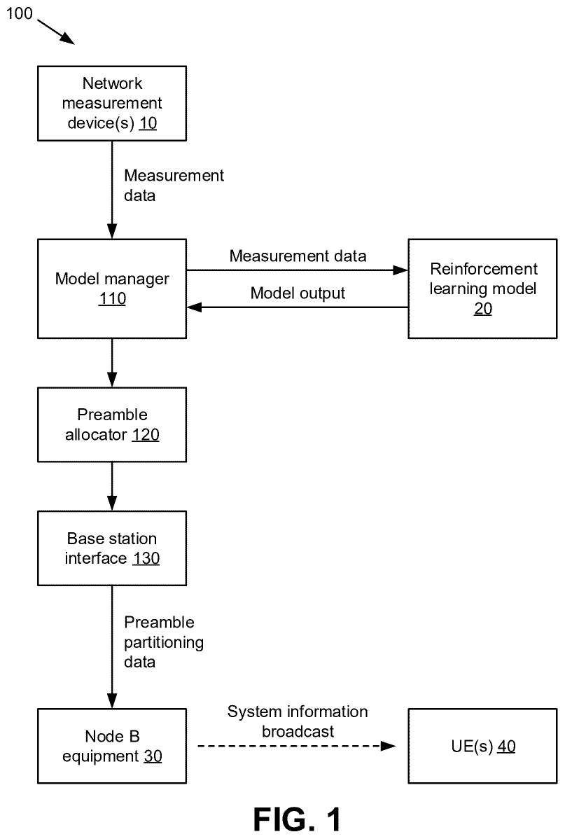

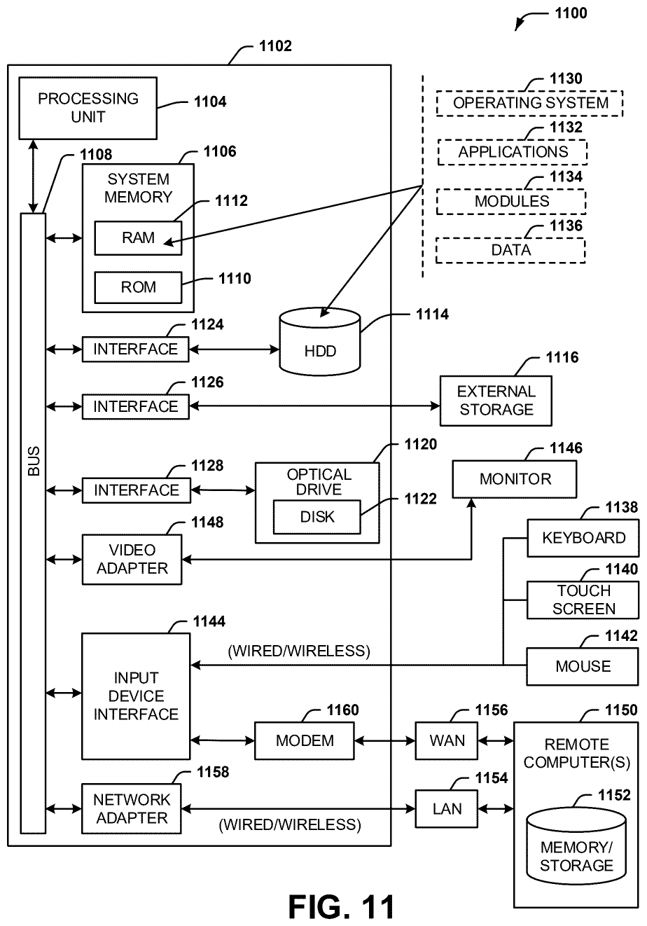

With reference now to the drawings, FIG. 1 illustrates a block diagram of a system 100 that facilitates dynamic redistribution of RACH preamble resources in accordance with various implementations described herein. System 100 as shown in FIG. 1 includes executable components, e.g., a model manager 110, a preamble allocator 120, and a base station interface 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIG. 11. In some implementations, the executable components 110, 120, 130 of system 100, and/or other elements of system 100, can communicate with each other via a bus and/or other components that provide intercommunication between various elements of system 100.

Additionally, it is noted that the functionality of the respective components shown and described herein can be implemented via a single computing device and/or a combination of devices. For instance, in various implementations, the model manager 110 shown in FIG. 1 could be implemented via a first device, the preamble allocator 120 could be implemented via the first device or a second device, and the base station interface 130 could be implemented via the first device, the second device, or a third device. Also, or alternatively, the functionality of a single component could be divided among multiple devices in some implementations.

As will be described in further detail below, the components 110, 120, 130 of system 100 can interact with one or more devices associated with a communication network, such as network measurement devices 10, Node B equipment (base station equipment, eNB or gNB equipment, etc.) 30, and/or other suitable devices. It is noted that the components 110, 120, 130 could themselves be implemented as part of the network measurement device(s) 10 and/or Node B equipment 30, or alternatively one or more devices implementing system 100 could be separate from said devices and communicate with other devices associated with system 100 through any suitable wired and/or wireless communication technology(-ies).

With reference now to the components of system 100, the model manager 110 of system 100 can input measurement data, such as data relating to measurements performed and/or otherwise collected by network measurement devices 10 in relation to a KPI or other performance metric of a communication network associated with system 100, to a RL model 20 and/or another suitable machine learning model. Based on an output generated by the RL model 20 in response to the measurement data provided as input to the RL model 20 by the model manager 110, the preamble allocator 120 of system 100 can adjust an allocation of RACH preambles utilized by a communication network, e.g., between a first group of contention-based RACH preambles and a second group of non-contention-based (contention-free) RACH preambles.

Upon completion of the preamble reallocation performed by the preamble allocator 120, the base station interface 130 of system 100 can cause Node B equipment 30, or other base station equipment associated with the communication network, to transmit information relating to the adjusted RACH preamble allocation provided by the preamble allocator 120, e.g., in a system information broadcast that can be received by one or more UEs 40 and/or other devices operating in the communication network. These UEs 40 and/or other devices can then, in turn, utilize the updated RACH preamble allocations to facilitate random access procedures in the network with improved performance (e.g., in terms of higher data throughput, shorter access delays, fewer access failures, etc.) as compared to a system in which RACH preambles are assigned statically.

The RACH procedure, for which RACH preambles are used, is a fundamental aspect of modern communication networks, such as LTE and 5G networks. The RACH procedure allows UEs to initiate communication with the network, facilitating activities such as (1) initial access, e.g., when a UE first connects to the network; (2) handover (HO), e.g., when a UE moves from one cell to another; (3) periodic updates, e.g., to enable a UE to update it status with the network; and/or other activities. As noted above, efficient allocation of RACH preambles is desirable to facilitate optimal network performance. Misallocation of RACH preambles can lead to resource underutilization or excessive access delays, which in turn can impact overall network performance and user experience. Moreover, methods of preamble allocation that utilize static or pre-configured partitioning lack the flexibility to adapt to real-time network conditions. In contrast, implementations described herein provide a novel approach, e.g., using deep reinforcement learning (DRL), to dynamically optimize the allocation of RACH preamble resources.

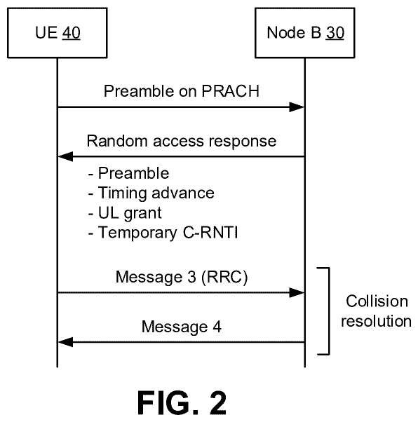

A general overview of the RACH procedure is shown by FIG. 2. Prior to the message exchanges shown in FIG. 2, RACH preamble allocations associated with a given cell, e.g., a cell associated with a Node B 30, can be configured at the Node B 30. In some implementations, the RACH preamble space can consist of a defined number of valid preambles (e.g., 64 preambles, etc.), and the Node B 30 can be configured (either statically or dynamically in connection with one or more implementations described herein) to allocate respective ones of the valid preambles between contention-based and non-contention-based preambles, e.g., resulting in an allocation of N contention-based preambles and (X-N) non-contention-based preambles, where X is the total number of available preambles. Information regarding the preamble allocations can then be conveyed by the Node B 30 to the UE 40, e.g., in a system information broadcast and/or via any other suitable messaging type(s).

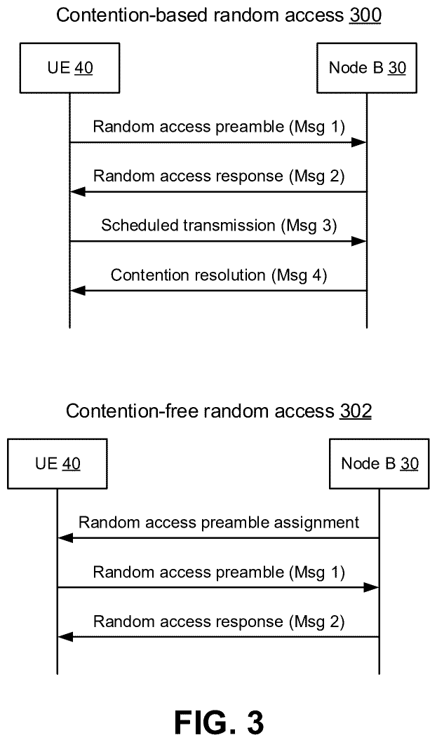

Based on the RACH preamble allocations as described above, the UE 40 can initiate a random access procedure as shown in FIG. 2 by transmitting an appropriate RACH preamble on a physical RACH (or PRACH), e.g., as referred to herein as message 1. As will be further described below with respect to FIG. 3, the preamble utilized by the UE 40 can be determined either by the UE 40 itself or by the Node B 30, depending on the type of random access desired. The Node B 30 can then respond to the preamble transmission with a random access response (e.g., message 2), which can include timing and/or resource information such as updated preamble information, timing advance information, an uplink (UL) resource grant, a temporary cell radio network temporary identifier (C-RNTI) to be used by the UE 40, and/or other information.

In response to the random access response, the UE 40 can then transmit a connection request to the Node B 30 (e.g., message 3) via radio resource control (RRC) signaling and/or other means. Subsequently, the Node B 40 can resolve any contention among multiple UEs 40, e.g., via message 4 as shown in FIG. 2.

Turning now to FIG. 3, variations in the general procedure shown by FIG. 2 are illustrated for both the case of contention-based random access (CBRA) 300 and contention-free random access (CFRA) 302. With reference first to the procedure for CBRA 300, the UE 40 can initially transmit a random access preamble in message 1, which can be selected (e.g., randomly selected) by the UE 40 from a list of available contention-based preambles. As noted above, contention-based preambles can be used when multiple UEs 40 might simultaneously attempt access, leading to potential collisions. After the transmission of a random access response (message 2) and a scheduled transmission (message 3) that can occur in a similar manner to that described above with reference to FIG. 2, the network can resolve any potential collisions through a contention resolution process, e.g., initiated via message 4 as sent by the Node B 30 to the UE 40. In some implementations, the contention resolution message (message 4) sent by the Node B 30 as shown in FIG. 3 can assign a time delay or backoff to one or more UEs 40 attempting CBRA on the same RACH preamble, e.g., causing those UEs 40 to attempt retransmission of message 3 on UE-specific time delays and enabling the Node B 30 to process those transmissions one at a time without interference from other contending UEs 40.

In contrast to the procedure for CBRA 300, the procedure for CFRA 302 shown in FIG. 3 can begin via the Node B 30 selecting a non-contention-based RACH preamble, e.g., from a list of available non-contention-based preambles, and assigning that preamble to a given UE 40 via an assignment message. As noted above, non-contention-based preambles can be allocated for specific UEs 40, e.g., during handover scenarios and/or other scenarios where the risk of collision is minimal. Because the UE 40 is assigned a dedicated RACH preamble that should not be used by other UEs 40 for the duration of the CFRA procedure, the CFRA 302 can be completed via the random access preamble and random access response message exchanges (e.g., messages 1 and 2, respectively), without a contention resolution procedure as in CBRA 300.

The performance of wireless communication networks, such as those based on the LTE and/or 5G standards, can be dependent on the efficient management of the RACH procedure, e.g., as described above with respect to FIGS. 2-3. The RACH process can be used, e.g., to enable a UE 40 to establish initial contact with the network, perform handovers, and request resources. Central to this process are RACH preambles, which are short sequences transmitted by UEs to signal their intent to access network services.

Traditional methods for allocating RACH preambles generally utilize static or pre-configured allocations that are based on historical data and/or fixed assumptions about network conditions. However, this rigidity fails to account for the dynamic and fluctuating nature of real-world network environments. By way of example, static RACH preamble allocation can lead to inefficient use of available preambles. For instance, during periods of low handover activity, non-contention-based preambles may remain underutilized, while contention-based preambles may be insufficient during peak access attempts, causing delays and collisions.

Additionally, static RACH preamble allocations can result in reduced efficiency in collision and/or contention management scenarios. For example, in high-demand situations, multiple UEs may attempt to access the network simultaneously using contention-based preambles, leading to collisions. The subsequent contention resolution process can introduce significant delays, reducing network efficiency and user satisfaction. Moreover, network traffic patterns are inherently variable, influenced by factors such as time of day, user mobility, and application usage trends. Static allocation fails to adapt to these variations, exacerbating collision issues and degrading performance.

Further, static RACH preamble allocations can similarly reduce the efficiency of handover procedures. For instance, non-contention-based preambles can be used to facilitate seamless handovers, ensuring UEs can smoothly transition between cells without service interruption. Poor allocation of these preambles can lead to handover failures, dropped connections, and reduced quality of service (QoS).

The efficiencies arising from static RACH preamble allocation and poor contention management, e.g., as described above, can have direct and adverse impacts on network performance. For instance, inefficient preamble allocation can cause UEs to experience longer wait times and repeated attempts to access the network, leading to user frustration. Further, high collision rates and failed handovers can contribute to lower overall network throughput, diminishing the quality of experience for all users. Frequent collisions and contention resolution processes can also generate additional signaling traffic, consuming valuable network resources that could be better utilized for data transmission.

To address the above and/or other challenges, implementations described herein can provide a dynamic, adaptive solution that can intelligently manage RACH preamble allocation in real-time. By way of example, implementations described herein can enable adaptation to real-time network conditions, e.g., via continuous monitoring and facilitating expedient responses to changes in network traffic, user density, and mobility patterns. Implementations described herein can also optimize resource utilization, e.g., by balancing the distribution of contention-based and non-contention-based preambles to maximize efficiency and minimize delays. Implementations described herein can further enhance user experience, e.g., by reducing access delays, improving handover success rates, and increasing overall network throughput.

Various implementations described herein can utilize DRL to dynamically optimize the distribution of preambles between CBRA and CFRA based on real-time network conditions. DRL combines neural networks with reinforcement learning principles, enabling the creation of agents that can learn optimal strategies through interaction with their environment. A DRL-based system for RACH preamble allocation as described herein can (1) learn from network data, e.g., by utilizing extensive historical and real-time network operation data to understand patterns and predict future conditions; (2) make intelligent decisions, e.g., by continuously adjusting preamble allocations based on real-time feedback, optimizing resource utilization dynamically; and (3) self-improve over time, e.g., by adapting and refining its policies through ongoing interaction with the network environment, ensuring sustained performance improvements.

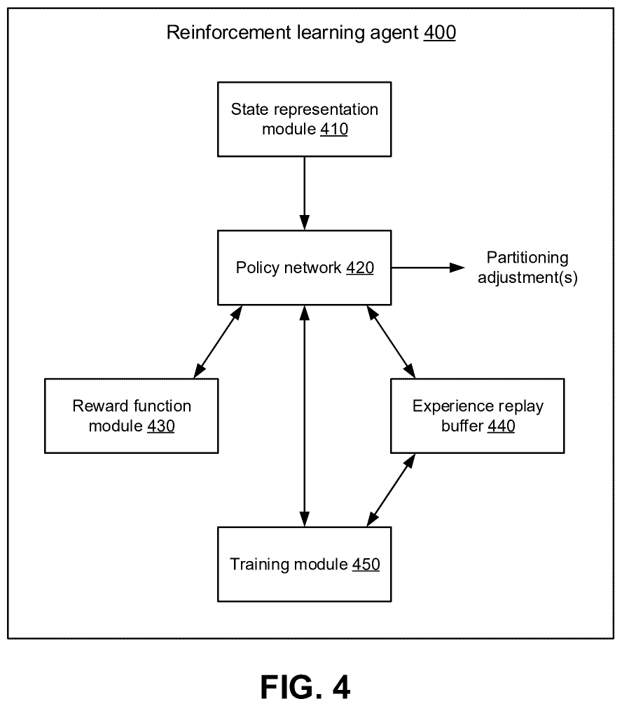

With reference now to FIGS. 4-6, respective components and subsystems of a system that facilitates dynamic redistribution of RACH preamble resources in accordance with various implementations described herein are provided. Repetitive description of like parts described above with regard to other implementations is omitted for brevity. The system shown in FIGS. 4-6 can be utilized to facilitate integration of DRL and/or other machine learning techniques with real-time network management, ensuring adaptive and intelligent decision-making. The system can include a RL agent 400, as shown in FIG. 4, which can dynamically adjust RACH preamble allocations in real-time based on current network conditions. This can, in turn, significantly improve KPIs such as access delay, collision rate, successful access rate, throughput, and handover success rate.

The RL agent 400 shown in FIG. 4 includes a state representation module 410, which can convert raw network data into structured state vectors, ensuring comprehensive representation of current network conditions. The RL agent 400 further includes a policy network 420, a reward function module 430, an experience replay buffer 440, and a training module 450, which can facilitate continuous learning and adaptation of the RL agent 400 as described in further detail below. For instance, the RL agent 400 can undergo both offline training (e.g., with simulated or historical data) and online training with real-time data, ensuring it remains effective even as network conditions evolve.

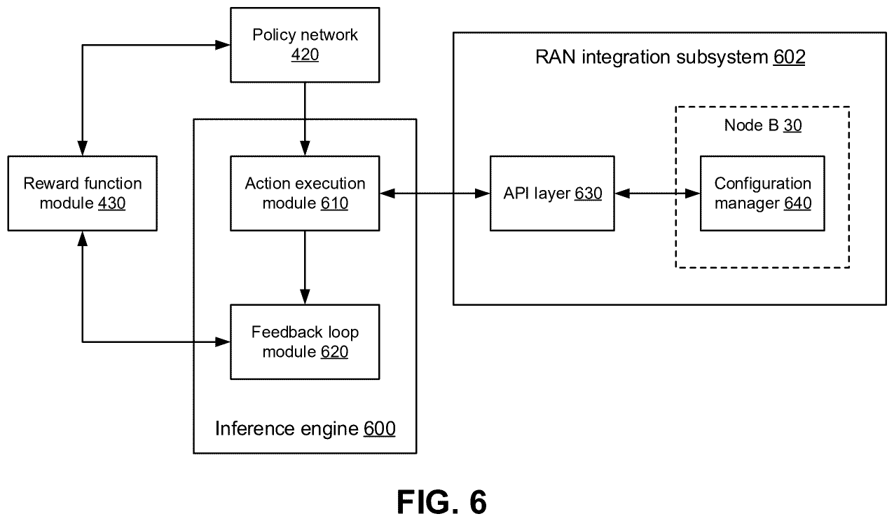

Once trained, the policy network 420 shown in FIG. 4 can make real-time decisions on preamble allocation, which can be executed via an inference engine 600 as will be described in further detail below with reference to FIG. 6. As will be further described below with reference to FIG. 6, a feedback loop can continuously monitor network performance, providing real-time data for further tuning and updating the policy network 420.

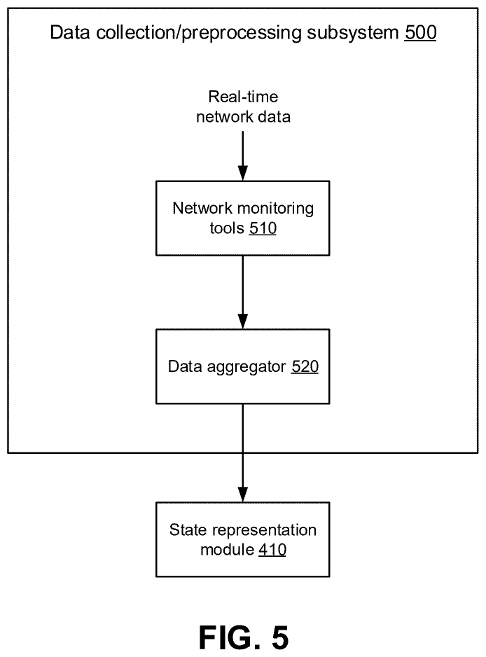

As will additionally be described in further detail below with reference to FIG. 5, a data collection and preprocessing subsystem 500 can employ network monitoring tools 510 such as probes, sensors, and/or advanced network management systems to collect accurate and real-time network performance data. One or more data analytics techniques can then be utilized to analyze large volumes of collected network data, extracting insights and identifying patterns that can inform the decision-making process used by the RL agent 400.

The system shown by FIGS. 4-6 can also facilitate seamless integration with a radio access network (RAN), e.g., via a RAN integration subsystem (RIS) 602 as shown in FIG. 6. The RIS 602 can feature an application programming interface (API) layer 630 for secure and efficient communication between the RL agent 400 and RAN components. Additionally, a configuration manager 640 can ensure that actions are feasible and comply with network policies, facilitating seamless integration and operation within the existing network infrastructure. The RIS 602 and its components are described in additional detail below.

In implementations, the goal of the system shown by FIGS. 4-6 is to dynamically optimize the allocation of RACH preambles in a wireless communication network, e.g., using DRL or other techniques, in order to reduce access delays and collisions as well as enhance overall network performance. Aspects of the problem formulation that can be utilized by the system are described below, including key performance indicators (KPIs), mathematical expressions, and associated constraints.

Returning now to FIG. 4, KPIs can be chosen for consideration by the RL agent 400, e.g., to enable the RL agent 400 to have the ability to properly determine the impact of its preamble assignment decisions on network performance and/or UE performance. Examples of KPIs that can be used in this manner are as follows:
1) Access delay [symbol] , representing the average time taken for a UE to successfully access the network. For instance, as noted above with reference to FIGS. 2-3, the contention resolution process can cause a colliding UE to wait for a defined backoff time before attempting to access the network again, which could be repeated if collisions persist on repeated attempts. This amount of time, both in terms of the backoff time and the time spent performing access attempts, can contribute to access delay. Access delay can be expressed as follows:

$$𝒟 = \frac{1}{N} {\sum }_{i = 1}^{N} {d}_{i}$$

where dᵢ is the access delay for the i-th UE and N is the total number of UEs attempting access.
2) Collision rate [symbol] , representing the proportion of RACH preamble attempts that result in collisions (e.g., due to multiple UEs attempting to use the same contention-based preamble). The collision rate can be expressed as follows:

$$𝒞 = \frac{{L}_{collisions}}{{L}_{attempts}}$$

where L_{collisions} is the number of collisions and Lₐₜₜₑₘₚₜₛ is the total number of RACH preamble attempts.
3) Successful access rate [symbol] , representing the proportion of RACH preamble attempts that result in successful access. This can be expressed as follows:

$$= \frac{{L}_{successes}}{{L}_{attempts}}$$

where L_{successes} is the number of successful accesses and Lₐₜₜₑₘₚₜₛ is the total number of RACH preamble attempts.
4) Data throughput [symbol] , representing the total amount of data successfully transmitted over the network. The data throughput [symbol] can be expressed as a sum of throughputs for respective UEs, e.g., as follows:

$$𝒯 = {\sum }_{i = 1}^{N} {R}_{i}$$

where Rᵢ is the throughput for the i-th UE (of N UEs).
5) Handover success rate [symbol] , representing the proportion of handovers in the network that are successfully completed without dropping the connection. This can be expressed as follows:

$$ℋ = \frac{{O}_{successes}}{{O}_{attempts}}$$

where O_{successes} is the number of successful handovers and Oₐₜₜₑₘₚₜₛ is the total number of handover attempts.

In addition to the above KPIs, other KPIs could also be used.

Based on the above and/or other KPIs, the RL agent 400 can formulate an optimization problem where the objective is to maximize network performance by optimizing the allocation of RACH preambles. Stated another way, the RL agent 400 can operate with the goal of learning a policy π that maps states of the network (Sₜ) to actions (aₜ) that determine the allocation of preambles. To this end, the state representation module 410 of the RL agent 400 can generate and/or otherwise utilize a state vector that is representative of an average of one or more KPIs or other performance metrics over a given time window, the partitioning of the RACH preamble space over the same time window, and/or other data points, based on which the policy network 420 of the RL agent 400 can generate an output.

In an implementation, the state vector can be defined as a vector Sₜ that represents the state of the network at time t, e.g., in terms of the number of UEs, current allocation of preambles, traffic load, or other parameters. By way of specific, non-limiting example, the state vector can utilize one or more of the above-referenced KPIs as follows:

$${S}_{t} = [ \frac{1}{τ} {\sum }_{i = t - τ + 1}^{t} {𝒞}_{i} , \frac{1}{τ} {\sum }_{i = t - τ + 1}^{t} {𝒟}_{i} , \frac{1}{τ} {\sum }_{i = t - τ + 1}^{t} {ℋ}_{i} , \frac{1}{τ} {\sum }_{i = t - τ + 1}^{t} \frac{{a}_{cb}^{i}}{{a}_{ncb}^{i}} ]$$

where [symbol] ᵢ is the collision rate at time i, [symbol] ᵢ is the access delay at time i, [symbol] ᵢ is the handover success rate at time i,

$${a}_{cb}^{i}$$

is the number of contention-based preambles allocated at time i,

$${a}_{ncb}^{i}$$

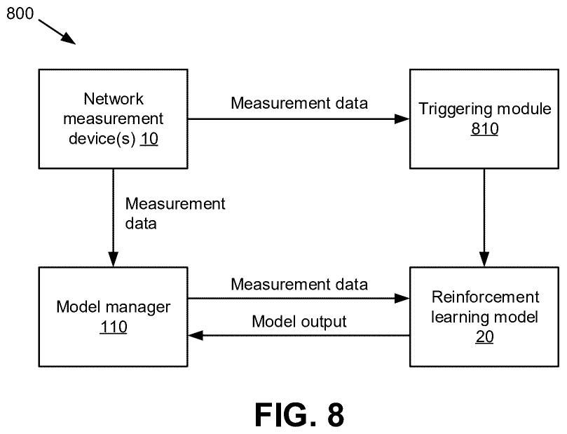

is the number of non-contention-based preambles allocated at time i, and τ is a configurable vector update frequency. In some implementations, τ can correspond to a frequency at which the policy network 420 alters the preamble partitioning (e.g., every 24 hours, or at a different frequency based on the needs of the network). In other cases, such as will be described in further detail below with respect to FIG. 8, actions taken by the policy network 420 can be initiated based on various triggering criteria in addition to, or in place of, occurring at regular intervals.

In addition, the policy network 420 can define a parameter aₜ as the action taken by the RL agent 400 at time t, e.g., to adjust the number of contention-based and non-contention-based preambles. This can be represented as follows:

$${a}_{t} = \{ {a}_{cb}^{t} , {a}_{ncb}^{t} \}$$

where a_{cb} and a_{nch} are the number of contention-based and non-contention-based preambles at time t, respectively.

As further shown in FIG. 4, the policy network 420 can generate an output further based on a reward function associated with a reward function module 430. By way of example, the reward function module 430 can define a reward function rₜ to represent the reward received after taking action aₜ in state Sₜ, e.g., based on the above definitions. In one example, the reward function rₜ can be a weighted sum of respective performance metrics over a given time window (e.g., a learning epoch), such as the following with respect to the KPIs defined above:

$${r}_{t} = α \cdot {t}_{} - β \cdot {𝒞}_{t} - δ \cdot {𝒟}_{t} + ϵ \cdot ℋ + ζ \cdot 𝒯$$

where α, β, δ, ϵ, and ζ are operator-configurable weights that balance the importance of each KPI to a given network. In an implementation, the weights α, β, δ, ϵ, and ζ can be set such that they sum to 1.

In an implementation, the objective of the RL agent 400 can be defined as maximization of the average cumulative reward over time, e.g., represented as respective learning epochs t, which as noted above can be related to the network KPIs. This can be expressed as follows:

$${max}_{π} 𝔼 [ {\sum }_{t = 0}^{∞} {γ}^{t} {r}_{t} ]$$

where γ∈[0, 1] is a discount factor for the time-accumulated reward. The RL agent 400 can utilize a weighted sum of the reward, e.g., instead of the instantaneous reward at a given point in time, to minimize the potential impact of spikes in the reward function that could skew the operation of the policy network 420.

In some implementations, the policy network 420 can also operate according to additional constraints on performable actions. These constraints can include, but are not necessarily limited to, the following:
1) The total number of preambles available for use should remain constant, e.g., a_{cb,t}+a_{ncb,t}=X for all times t, where X is the total number of preambles available to the network (e.g., as given by a totalNumberOfRA-Preambles configuration property of the network and/or other suitable sources).
2) The number of contention-based and non-contention-based preambles should remain within defined minimum and maximum values, e.g.,

$${a}_{cb}^{min} \leq {a}_{cb}^{t} \leq {a}_{cb}^{max} and {a}_{ncb}^{min} \leq {a}_{ncb}^{t} \leq {a}_{ncb}^{max} ,$$

respectively, for all times t.
3) The number of contention-based and non-contention-based preambles should always be at least 0, e.g., a_{cb,t}≥0 and a_{ncb,t}≥0.
4) The number of preambles allocated as contention-based and non-contention-based preambles should not change by more than a configurable delta value at any one time, e.g.,

$$\vert {a}_{cb}^{t} - {a}_{cb}^{t - 1} \vert \leq {Δ}_{cb}$$

for contention-based preambles and

$$\vert {a}_{ncb}^{t} - {a}_{ncb}^{t - 1} \vert \leq {Δ}_{ncb}$$

for non-contention based preambles.

Other constraints could also be used.

In an implementation, a system for dynamic redistribution of RACH preamble resources includes several components and functional blocks, e.g., as shown by FIGS. 4-6, each playing a role in the overall operation and optimization process. The system can operate in a network environment, e.g., a network environment including UEs 40, which can attempt to access the network, and one or more Node Bs 30 (e.g., eNBs or gNBs), which are nodes that can manage the RACH process and facilitate communication between UEs and a core network. The core network, in turn, can handle routing, mobility management, and/or other higher-level services.

With specific reference now to FIG. 4, the RL agent 400 of the system shown by FIGS. 4-6 can be implemented via any suitable device(s), which could either be part of the network and/or standalone computers or other devices that communicate with the network via a wired or wireless communication protocol. By way of non-limiting example, the RL agent 400 could be implemented directly on a Node B 30 and/or one or more server devices that have a direct communication link with the Node B. In other non-limiting examples, the RL agent 400 could be implemented on offline servers that can communicate with a Node B 30 and/or an associated core network, one or more edge network elements, and/or other suitable network components. The term “offline servers,” in this context, refers to server devices that are not directly part of a network with which they communicate. As a result of the system structures shown by FIGS. 4-6, however, it is noted that the operation of the RL agent 400 and/or other system components can be substantially the same regardless of the specific location(s) of the system components.

With reference to the components of the RL agent 400, the state representation module 410 can collect and process input data, including real-time network data relating to KPIs, network conditions, current configuration parameters, and/or other factors, to generate a comprehensive state vector representing the current network conditions, e.g., as described above. The policy network 420 can implement a neural network and/or other suitable machine learning techniques to map state representations provided via the state representation module 410 to actions, e.g., an adjusted partitioning/allocation of preambles between contention-based and non-contention-based random access. Additionally, the reward function module 430 of the RL agent 400 can, based on a defined reward function (e.g., as described above), compute a reward based on measured network performance metrics after an action is taken as a result of decisions made by the policy network 420.

The experience replay buffer 440 can store past experiences (e.g., defined via [state, action, reward, next state] tuples and/or in other suitable ways) to stabilize training and/or model outputs. For instance, the experience replay buffer 440 can be utilized to store outputs generated by the policy network 420 in response to previous network measurements and/or other indicators of the network state. Subsequently, in the event that input network measurements exhibit at least a threshold degree of similarity (e.g., according to defined similarity criteria or metrics) to network measurements stored by the experience replay buffer 440 for which an output has previously been generated by the policy network 420, the experience replay buffer 440 can restrict any output generated by the policy network 420 for the current input measurement(s) to be within a defined threshold variance of the output previously generated by the policy network 420 for the stored input measurements. As a result, the experience replay buffer 440 can ensure consistency of the policy network 420, e.g., by preventing the policy network 420 from making drastic changes to its decisions compared to previously stored decisions for the same or similar input states.

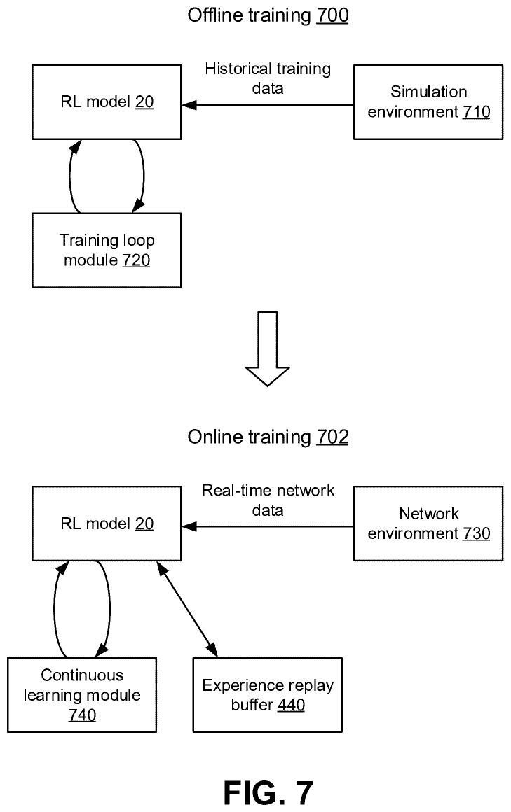

As further shown in FIG. 4, the training module 450 of the RL agent 400 can facilitate online and/or offline training of the policy network 420, e.g., based on simulation or historical data, experiences stored in the experience replay buffer, real-time data, and/or other suitable data. Training techniques that can be utilized by the training module 450 are described in further detail below with respect to FIG. 7.

Turning now to FIG. 5, a data collection and preprocessing subsystem (DCPS) 500 is illustrated, which can collect and compile input data for the state representation module 410 of the RL agent 400 described above with reference to FIG. 4. The DCPS 500 shown in FIG. 5 can include one or more network monitoring tools 510 that can collect real-time network data, including (but not limited to) the number of UEs operating in the network, traffic load, collision rates, access delays, handover statistics, and/or other data. This data can then be provided to a data aggregator 520, which can aggregate and preprocess the collected data to aid in forming state representations for the RL agent 400 described above with reference to FIG. 4.

In implementations, the DCPS 500 can utilize robust measurement technologies to ensure accurate and efficient optimization. For instance, the network monitoring tools 510 can include respective probes, sensors, and/or other measurement tools that can be deployed at various points in the network to collect real-time data on traffic load, access attempts, collision rates, delays, or the like. The network monitoring tools 510 can also include a network management system, which can aggregate and process data from the probes, sensors, and/or other tools to provide a comprehensive view of network performance.

Also or alternatively, the network monitoring tools 510 shown in FIG. 5 can receive data via periodic measurement reports sent by UEs to the base stations of the network. These UE measurement reports can include data such as signal strength, quality, and access attempts. In addition, the network monitoring tools 510 shown in FIG. 5 can include and/or otherwise interact with handover management systems, which can track handover attempts and successes in order to monitor and optimize handover success rates.

In further implementations, the data aggregator 520 can implement one or more data aggregation and/or analysis tools. For instance, the data aggregator 520 can utilize big data technologies to analyze large volumes of network data, extract insights, and identify patterns that can inform the decision-making process of the RL agent 400. By way of specific, non-limiting example, the data aggregator 520 can leverage distributed storage and processing frameworks, such as Hadoop and/or Spark, to this end. Also or alternatively, the data aggregator can employ machine learning pipelines to preprocess data, train models, and/or validate performance. These pipelines can be used to ensure that the data fed into the RL agent 400 is clean, relevant, and up to date.

With reference next to FIG. 6, additional elements of the system shown by FIGS. 4-6, including an inference engine 600 and a RAN integration subsystem (RIS) 602, are shown. While portions of the elements shown in FIG. 6 are illustrated as being associated with a Node B 30, it is noted that some or all of the functionality of the inference engine 600 and/or RIS 602, or the system illustrated by FIGS. 4-6 more generally, could be implemented via a Node B 30 and/or other network equipment in addition to, or in place of, that which is illustrated by FIG. 6.

The inference engine 600 shown in FIG. 6 includes an action execution module 610, which can implement respective actions decided by the policy network 420 (e.g., as described above with reference to FIG. 4) in the RAN, e.g., with the aid of the RIS 602 as described below. The feedback loop module 620 of the inference engine 600 can continuously collect feedback relating to network performance after implementing actions via the action execution module 610. This feedback can be used, either individually via the feedback loop module 620 or in combination with the reward function module 430 of the RL agent 400, to inform future decisions.

The RIS 602 shown in FIG. 6 includes an API layer 630, which can provide one or more interfaces for communication between the RL agent 400, other system components such as the inference engine 600, and the RAN components on which actions are to be implemented, e.g., a Node B 30. In an implementation, the API layer 630 can facilitate an API layer connection between the RL agent 400 and a Node B 30, enabling partitioning adjustments for RACH preambles and/or other actions to be taken to be communicated to the Node B 30 via the API layer connection.

The RIS 602 further includes a configuration manager 640, which can manage configuration parameters and constraints for preamble allocation at one or more Node Bs 30 based on information received via the API layer 630. As described above with reference to FIG. 1, a Node B 30 associated with the configuration manager 640 can then transmit updated cell configuration information, including information relating to changes to the RACH preamble allocation, to one or more UEs 40, e.g., in a system information broadcast.

Turning now to FIG. 7, phases of a process that can be utilized to train a RL model 20, such as that described above with reference to FIG. 1 and/or an RL model associated with an RL agent 400 as described above with reference to FIG. 4, is illustrated. In an implementation, the training process shown by FIG. 7 can serve as the training phase of a technique for integrating an RL-based system with a RAN that includes the training phase as well as an inference phase.

The training phase shown in FIG. 7 is divided into an offline training phase 700 followed by an online training phase 702. During the offline training phase, the RL model 20 is trained offline using historical network data and simulations, e.g., as provided via a simulation environment 710, to facilitate initial optimization of the RL model 20 prior to exposing the RL model 20 to real-world data. The offline training phase 700 can include an initial data collection step, in which a set of historical data on network conditions and performance metrics that is sufficiently extensive to facilitate model training is gathered. Next, the simulation environment 710 can be created that mimics real network conditions in order to train the RL model 20. Finally, the RL model 20 can undergo a training loop (shown via a training loop module 720 in FIG. 7) in which the RL model 20 interacts with the simulation environment 710, taking actions and receiving rewards, to learn an optimal policy for the simulation environment 710. It is noted that actions taken by the RL model 20 in the offline training phase 700 can be used solely for the purposes of analyzing the resulting reward in the simulation environment 710 to facilitate training, e.g., as opposed to altering any real-world network components.

Once the RL model 20 has reached an optimal level of rewards in the offline training phase 700 (e.g., such that an expected reward over time associated with the RL model 20 is determined to be at or near a maximum reward given the simulation data), the RL model 20 can enter the online training phase 702, in which the RL model 20 undergoes training using real-time network data from a network environment 730. During the online training phase 702, the RL model can undergo continuous learning (shown via a continuous learning module 740 in FIG. 7) to continue to learn and refine its policy based on real-time feedback from the network. As further shown in FIG. 7, real-time experiences of the RL model 20 can be stored in an experience replay buffer 440, such as that described above with reference to FIG. 4, during the online training phase 702 for use in making periodic updates to the policy network.

Following the online training phase 702, the RL model 20 can enter an inference phase in which the trained policy network 420 is deployed in a live network to make real-time decisions on preamble allocations. By way of example, as shown in FIG. 6, actions determined by the policy network 420 can be executed in the RAN through the action execution module 610, and the feedback loop module 620 can provide continuous monitoring of network performance metrics to provide feedback for further tuning and updates.

Turning next to FIG. 8, a system 800 that facilitates RACH preamble reallocation based on changes in observed network conditions is illustrated. Repetitive description of like parts described above with regard to other implementations is omitted for brevity. System 800 as shown in FIG. 8 can include one or more network measurement devices 10 that provide measurement data to a model manager 110 for use by an RL model 20, e.g., as described above with reference to FIG. 1. In addition to, or in place of, facilitating RACH preamble updates at regular intervals, system 800 further includes a triggering module 810 that can cause the RL model 20 to generate an output (e.g., corresponding to an updated RACH preamble allocation) in response to various triggering conditions, such as determining that the measurement data provided via the network measurement devices 10 indicates a change of a network performance metric of at least some defined threshold. In this way, operation of the RL model 20 can in some cases be triggered outside of a normal update schedule in the event that large changes to network performance necessitate more frequent preamble allocation updates.

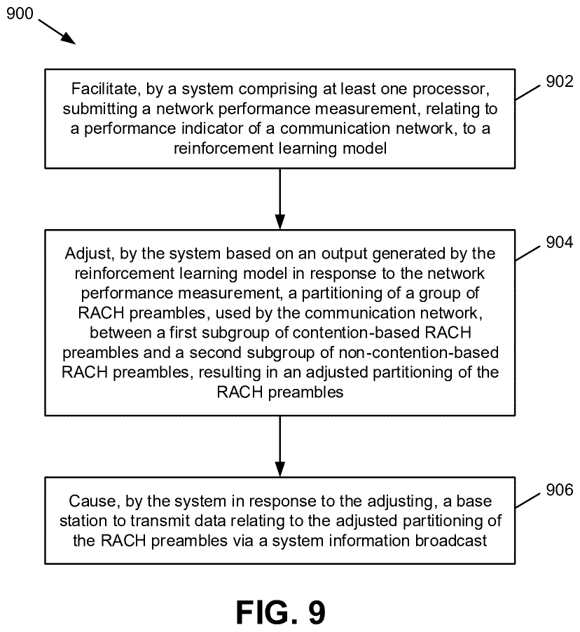

Referring now to FIG. 9, a flow diagram of a method 900 that facilitates dynamic redistribution of RACH preamble resources is illustrated. At 902, a system comprising at least one processor can facilitate (e.g., via a model manager 110) submitting a network performance measurement, relating to a performance indicator of a communication network, to an RL model (e.g., an RL model 20).

At 904, the system can adjust (e.g., by a preamble allocator 120), based on an output generated by the RL model in response to the network performance measurement provided to the RL model at 902, a partitioning of a group of RACH preambles, used by the communication network, between a first subgroup of contention-based RACH preambles and a second subgroup of non-contention-based RACH preambles, resulting in an adjusted partitioning of the RACH preambles.

At 906, in response to the adjustments performed at 904, the system can cause (e.g., by a base station interface 130) a base station (e.g., Node B equipment 30) to transmit data relating to the adjusted partitioning of the RACH preambles as determined at 904 via a system information broadcast.

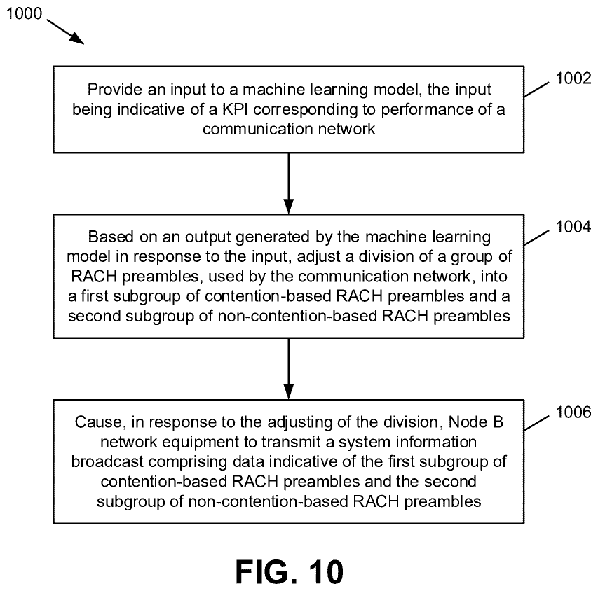

Referring next to FIG. 10, a flow diagram of a method 1000 that can be performed by at least one processor, e.g., based on machine-executable instructions stored on a non-transitory machine-readable medium, is illustrated. An example of a computer architecture, including a processor and non-transitory media, that can be utilized to implement method 1500 is described below with respect to FIG. 11.

Method 1000 can begin at 1002, in which the at least one processor can provide an input to a machine learning model, the input being indicative of a KPI corresponding to performance of a communication network.

At 1004, based on an output generated by the machine learning model in response to the input provided to the model at 1002, the at least one processor can adjust a division of a group of RACH preambles, used by the communication network, into a first subgroup of contention-based RACH preambles and a second subgroup of non-contention-based RACH preambles.

At 1006, in response to the adjustment performed at 1004, the at least one processor can cause Node B network equipment to transmit a system information broadcast comprising data indicative of the first subgroup of contention-based RACH preambles and the second subgroup of non-contention-based RACH preambles.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 11 and the following discussion are intended to provide a brief, general description of a suitable computing environment 1100 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
inputting measurement data, relating to a performance metric associated with a communication network, to a reinforcement learning model;
adjusting, based on an output generated by the reinforcement learning model in response to the inputting of the measurement data, an allocation of random access channel (RACH) preambles, used by the communication network, between a first group of contention-based RACH preambles and a second group of non-contention-based RACH preambles, resulting in an adjusted allocation of the RACH preambles; and
causing, in response to the adjusting of the allocation of the RACH preambles, a Node B to transmit information relating to the adjusted allocation of the RACH preambles via a system information broadcast.

2. The system of claim 1, wherein the performance metric is selected from a group of performance metrics comprising an average user equipment network access delay, a RACH collision rate, a RACH success rate, a data throughput of the communication network, and a handover success rate.

3. The system of claim 1, wherein the reinforcement learning model generates a state vector, representative of an average of the performance metric over a time window and the allocation of the RACH preambles during the time window, and generates the output based on the state vector.

4. The system of claim 3, wherein the reinforcement learning model generates the output further based on a reward function, the reward function being a function of a weighted sum of averages of performance metrics, comprising the performance metric, over the time window.

5. The system of claim 4, and wherein the reinforcement learning model generates the output based on maximizing an average cumulative expected result of the reward function.

6. The system of claim 1, wherein the operations further comprise:
communicating the adjusted allocation of the RACH preambles to the Node B via an application programming interface layer connection to the Node B.

7. The system of claim 1, wherein the operations further comprise:
determining that the measurement data indicates a change in the performance metric of at least a threshold amount during a time window, wherein the reinforcement learning model generates the output in response to the determining.

8. The system of claim 1, wherein the operations further comprise:
training the reinforcement learning model using offline data, wherein the inputting of the measurement data to the reinforcement learning model is in response to determining that the training of the reinforcement learning model has successfully completed.

9. The system of claim 1, wherein the measurement data is first measurement data, wherein the output of the reinforcement learning model is a first output, and wherein the operations further comprise:
storing second outputs generated by the reinforcement learning model based on respective portions of second measurement data given as input to the reinforcement learning model prior to the first measurement data; and
in response to determining, with reference to a defined similarity criterion, that the first measurement data exhibits at least a threshold degree of similarity to a portion of the respective portions of the second measurement data, restricting the first output of the reinforcement learning model to be within a threshold variance of a second output, of the second outputs and corresponding to the portion of the respective portions of the second measurement data.

10. A method, comprising:
facilitating, by a system comprising at least one processor, submitting a network performance measurement, relating to a performance indicator of a communication network, to a reinforcement learning model;
adjusting, by the system based on an output generated by the reinforcement learning model in response to the network performance measurement, a partitioning of a group of random access channel (RACH) preambles, used by the communication network, between a first subgroup of contention-based RACH preambles and a second subgroup of non-contention-based RACH preambles, resulting in an adjusted partitioning of the RACH preambles; and
causing, by the system in response to the adjusting, a base station to transmit data relating to the adjusted partitioning of the RACH preambles via a system information broadcast.

11. The method of claim 10, wherein the performance indicator is selected from a group of performance indicators comprising an average user equipment network access delay, a RACH collision rate, a RACH success rate, a data throughput of the communication network, and a handover success rate.

12. The method of claim 10, wherein the reinforcement learning model generates a state vector, representative of an average of the performance indicator, as given in the network performance measurement, over a time window and the partitioning of the RACH preambles during the time window, and generates the output based on the state vector.

13. The method of claim 12, wherein the reinforcement learning model generates the output further based on maximizing an average cumulative expected result of a reward function, and wherein the reward function is a function of a weighted sum of averages of performance indicators, comprising the performance indicator, over the time window.

14. The method of claim 10, further comprising:
communicating, by the system, the adjusted partitioning of the RACH preambles to the base station via an application programming interface layer connection to the base station.

15. The method of claim 10, wherein the network performance measurement is a first network performance measurement, wherein the output of the reinforcement learning model is a first output, and wherein the method further comprises:
storing, by the system, second outputs generated by the reinforcement learning model in response to respective second network performance measurements submitted to the reinforcement learning model prior to the first network performance measurement; and
in response to determining, in accordance with a defined similarity metric, that the first network performance measurement exhibits at least a threshold degree of similarity to a second network performance measurement of the second network performance measurements, constraining the first output of the reinforcement learning model to be within a threshold window defined about a second output, of the second outputs and corresponding to the second network performance measurement.

16. A non-transitory machine-readable medium comprising computer executable instructions that, when executed by at least one processor, facilitate performance of operations, the operations comprising:
providing an input to a machine learning model, the input being indicative of a key performance indicator (KPI) corresponding to performance of a communication network;
based on an output generated by the machine learning model in response to the input, adjusting a division of a group of random access channel (RACH) preambles, used by the communication network, into a first subgroup of contention-based RACH preambles and a second subgroup of non-contention-based RACH preambles; and
causing, in response to the adjusting of the division, Node B network equipment to transmit a system information broadcast comprising data indicative of the first subgroup of contention-based RACH preambles and the second subgroup of non-contention-based RACH preambles.

17. The non-transitory machine-readable medium of claim 16, wherein the machine learning model generates a state vector, representative of an average of the KPI and the division of the group of RACH preambles during a time window, and generates the output based on the state vector.

18. The non-transitory machine-readable medium of claim 17, wherein the machine learning model generates the output further based on maximizing an average cumulative expected result of a reward function, and wherein the reward function is a function of a weighted sum of averages of KPIs, comprising the KPI, within the time window.

19. The non-transitory machine-readable medium of claim 16, wherein the operations further comprise:
communicating the data indicative of the first subgroup of contention-based RACH preambles and the second subgroup of non-contention-based RACH preambles to the Node B network equipment via an application programming interface layer connection to the Node B network equipment.

20. The non-transitory machine-readable medium of claim 16, wherein the input is a first input, wherein the output of the machine learning model is a first output, and wherein the operations further comprise:
storing second outputs generated by the machine learning model in response to respective second inputs provided to the machine learning model, the second inputs being indicative of respective states of the KPI of the communication network prior to providing the first input to the machine learning model; and
in response to determining that the first input exhibits at least a threshold degree of similarity to a second input of the second inputs, restricting the first output of the machine learning model to be within a threshold amount of a second output, of the second outputs and corresponding to the second input.
